(19) United States
(12) Patent Application Publication
(10) Pub. No.: US 2021/0283707 A1
(43) Pub. Date: Sep. 16, 2021

(54) WIRE GUIDE FOR WELDING

(71) Applicant: Reynaldo Sandoval, Pasadena, TX (US)

(72) Inventor: Reynaldo Sandoval, Pasadena, TX (US)

(21) Appl. No.: 16/816,112

(22) Filed: Mar. 11, 2020

(51) Int. Cl. B23K 9/32; B23K 37/02

(52) U.S. Cl. CPC B23K 9/32; B23K 37/0264

(57) ABSTRACT

A wire guide for metal inert gas (MIG) or tungsten inert gas (TIG) welding includes a strap with a plurality of holes. The strap is connected to a magnet through connectors. A holder may optionally be connected to one or both of the connectors for holding accessories. In embodiments, the strap may be leather and may contain a plurality of holes sufficient to hold a metal rod for welding in various directions through one or more of the holes

### BACKGROUND OF THE DISCLOSURE

### Field of the Invention

The present disclosure relates to wire guides for welding, in particular, TIG (tungsten inert gas) welding.

### Description of the Related Art

Materials may be joined together by welding them with a filler metal. During welding, a wire filler must be continuously advanced into a melt zone of the weld to supply fill metal. Tungsten inert gas (TIG) is an arc welding process wherein welding is performed by heating with an arc with a tungsten electrode. The hot tungsten electrode, arc, and weld pool are shielded by an inert gas. Filler metal is added by slowly and continuously feeding wire rod into the weld pool.

It is a longstanding problem in the art that the wire filler must be held steady for relatively long periods of time while the weld is being accomplished.

### SUMMARY OF THE INVENTION

A wire guide for tungsten inert gas (TIG) welding includes a strap with a plurality of holes. The strap is connected to one or more magnets through connectors. A holder may optionally be connected to one or both of the connectors for holding accessories. In embodiments, the strap may be leather and may contain a plurality of holes sufficient to hold a metal rod for welding in various directions through one or more of the holes.

Other features and aspects will be apparent from the following detailed description, the drawings, and the claims

### BRIEF DESCRIPTION OF THE DRAWINGS

FIG. 1 shows one embodiment of a wire guide of the present disclosure.

FIG. 2 shows an embodiment of a strap with a plurality of holes.

FIG. 3 shows an embodiment of a strap guiding a wire.

FIG. 4 shows an embodiment of a welder welding wire with a welding gun using a wire guide of the disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

The TIG wire guide of the disclosure may be used to weld the gap between pipes. It is difficult to keep a TIG wire steady between the gap while welding. The disclosed wire guide may improve a welder's skills by more than 75%. It may help a welder to make a better weld and may also improve welding for x-ray on pipe.

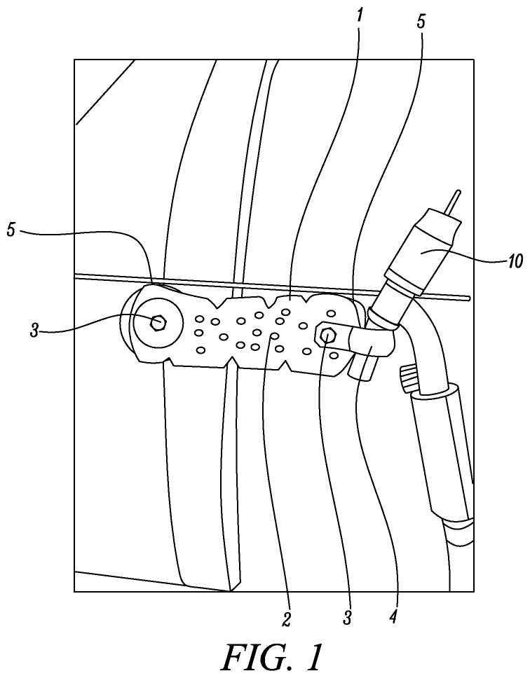

FIG. 1 shows one embodiment of a wire guide of the present disclosure. The wire guide of FIG. 1 shows strap 1 with plurality of holes 2. Strap 1 is connected to magnets 5 through connectors 3. As shown in FIG. 1, in embodiments, holder 4 may be connected to one or both of connectors 3 for holding accessories. In embodiments, strap 2 may contain a plurality of holes sufficient to hold a metal rod in various directions through one or more of the holes.

The strap may be made of leather in one example although any soft durable material natural or synthetic material capable of comprising holes and holding a length of wire may be used. The connectors may be nuts and bolts with washers but other connectors and connection methods and means may also be used as appropriate.

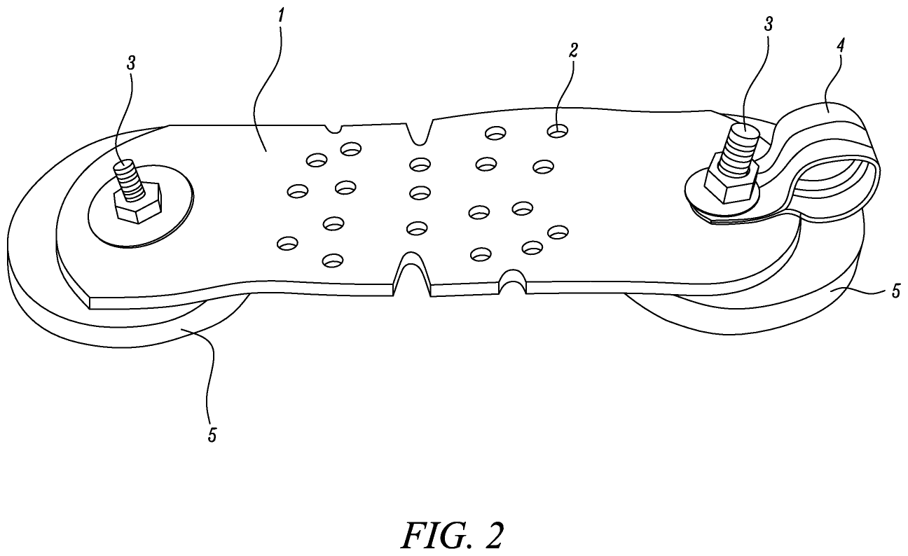

FIG. 2 shows a strap 2 including a plurality of holes.

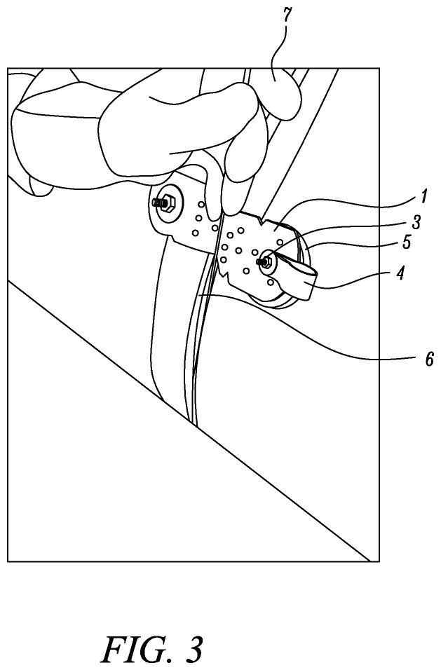

FIG. 3 shows strap 2 guiding wire 6.

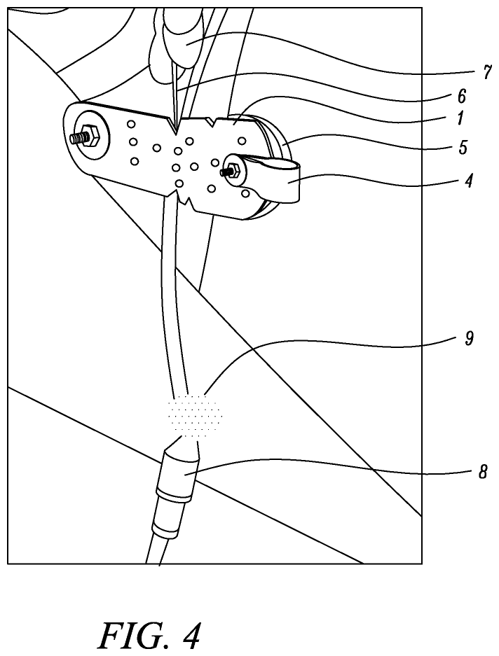

FIG. 4 shows welder 7 welding (9) wire 6 with welding gun 8.

While this disclosure includes specific examples, it will be apparent after an understanding of the disclosure of this application has been attained that various changes in form and details may be made in these examples without departing from the spirit and scope of the claims and their equivalents.

What is claimed is:

1. A wire holder for tungsten inert gas (TIG) welding comprising:
a strap comprising a plurality of holes;
two or more magnets with connectors for each magnet for connecting the strap to the magnets.

2. The wire holder of claim 1, wherein the strap comprises leather.

3. The wire holder of claim 1, further comprising a holder connected to at least one of the connectors.

4. The wire holder of claim 1, wherein the connector comprises a washer.
